(19) United States
(12) Patent Application Publication
(10) Pub. No.: US 2010/0203217 A1
(43) Pub. Date: Aug. 12, 2010

(54) Whole grains in consumable products

(76) Inventor: Malathy Nair, Hummelstown, PA (US)

Correspondence Address: Malathy Nair, 2159 Gelder Park Drive, Hummelstown, PA, 17036, US

(21) Appl. No.: 12/658,314

(22) Filed: Feb. 8, 2010

Related U.S. Application Data
(60) Provisional application No. 61/207,099, filed on Feb. 9, 2009.

(51) Int. Cl. A23L 1/187

(52) U.S. Cl. 426/579

(57) ABSTRACT

A composition comprising: a spoonable, creamy semisolid food product such as a RTE pudding containing whole grains either added as flour or slurry that has been adequately processed at high temperatures, either aseptic or UHT to ensure shelf life either at room temperature or refrigerated where the whole grain addition allows for a smooth and creamy texture product.

A whole grain slurry which is processed at adequate temperatures to ensure low microbial load and may be used to incorporate whole grains in several types of foods not limited to semi solid foods such as puddings, yogurts and sauces.

### CROSS-REFERENCE TO RELATED APPLICATIONS

This application claims priority to and the benefit of U.S. Provisional Application No. 61/207,099 entitled WHOLE GRAIN FLOUR INCORPORATION INTO SEMI-SOLID RTE FOOD PRODUCTS SUCH AS PUDDINGS, DIPS, SAUCES THAT ARE PROCESSED BY HIGH TEMPERATURE PROCESSING METHODS SUCH AS ULTRA HIGH TEMPERATURE/HOT FILL OR ASEPTIC PROCESSES filed Feb. 9, 2009.

### FIELD OF THE DISCLOSURE

The present disclosure is directed to methods to incorporate whole grains into semi solid food products. More particularly, the present disclosure is directed to semi solid spoonable food products where whole grains are incorporated while maintaining a smooth texture and methods to do so which includes formulating with whole grain flour and for production of a stable refrigerated or aseptically packaged whole grain paste or slurry that can be used as an ingredient to be incorporated into the semi solid food.

### BACKGROUND OF THE DISCLOSURE

Whole grains are incorporated today in several processed food products for consumption. Typically, whole grains have been added to cereals, bread and other baked goods. Either natural whole grains are used in such products or whole grain flour is used and the final products are usually dry foods. It is challenging to maintain optimum sensory characteristics of the product when natural whole grains are substituted or added to foods. It is particularly difficult to add whole grains into semi solid food products and yet maintain a smooth consistency product without particulates. Whole grain flour and/or whole grain flour slurry can be used to maintain the sensory characteristics, especially the texture of the food products

In products where whole grain flour is used, such as for example, baked goods, temperatures above 200 F is sufficient to kill and significantly reduce microbial counts.

In other examples of non baked goods or cereals, a non dairy based whole grain rice milk has been patented (4894242) where brown whole grain rice is enzymatically treated and non dairy based rice milk is produced which is consumed similar to milk or used in other desserts such as ice cream, incorporating the benefits of whole grain.

An aseptically packaged rice pudding has been produced (6596335) where parboiled medium rice has been used in high temperature and shear in UHT conditions to produce a rice pudding with a soft texture.

Whole grains have not been incorporated into RTE semi solid food products which are spoonable in nature such as puddings, yogurts, dips and sauces where the smooth, creamy texture can be maintained.

There is an unmet need to provide whole grains in semi solid spoonable food products such as puddings, yogurts, dips or sauces which can be achieved by using whole grain flour in the formula in combination with high heat process methods to maintain a smooth, creamy, spoonable texture, and/or by making a whole grain slurry that is thermally processed and stored either refrigerated or aseptically where additional healthy ingredients such as fiber or ultrafiltered high protein milk may be incorporated and the whole grain slurry may be directly added to yogurts, puddings or ice creams similar to incorporation of fruit concentrates in the process or the slurry may also be potentially used in food service application for directly adding whole grains to shakes, parfaits, sauces, dips, frozen yogurts, mousses.

### SUMMARY OF THE DISCLOSURE

This disclosure provides a semi solid food product, with whole grains, where preferably whole grain flour or finely powdered or micronized whole grains are added directly in the formula or a whole grain preprocessed slurry, stored refrigerated or aseptic, processed to ensure low microbial counts with or without additional added healthy components such as fiber, high protein milk, vitamins, minerals is added directly to the formula instead of whole grain flour and processed at ultra high temperature, aseptic temperatures similar to processes currently used to make aseptic or refrigerated semi solid foods. The slurry may be added during or post process to semi solid foods such as puddings, yogurts, dips, sauces and the microbial load in the whole grain flour is thereby reduced to safe levels due to the thermal process and a smooth and creamy semi solid food product containing whole grains is obtained.

According to an embodiment, whole grain flour or flour blends which have high microbial counts may be added to the formulation and high temperature processing allows the production of a semi solid food product with a smooth consistency.

According to another embodiment, whole grain flour or flour blends which have high microbial counts are combined with sugar and milk and thermally processed to produce a shelf stable or refrigerated slurry which can then be used as an ingredient component to enhance whole grains in food products, especially semi solid foods and with a smooth consistency.

An advantage of the present disclosure is ability to prepare a semi solid food product with whole grains having a similar texture and flavor as current ready to eat smooth puddings.

Still another advantage of the present disclosure is the production of a whole grain slurry or concentrate, which has been thermally processed and which may be additionally fortified and can be added during or post process to produce smooth and creamy semi solid food product with added whole grains

The features and advantages of the present disclosure will be appreciated and understood by those skilled in the art from the following detailed description.

### DETAILED DESCRIPTION OF THE DISCLOSURE

An embodiment of the present disclosure is a whole grain smooth semi-solid spoonable food product. The whole grains incorporated into the product has been subjected to high temperature processing conditions such as aseptic or UHT processing conditions in the range of 250-300 F or above to enable killing of the microbial flora. The use of whole grain flour allows addition of whole grain to semi solid foods to make a smooth food product. The ability to maintain a smooth and creamy texture with whole grains may be preferable or more universally acceptable with kids and older adults and allows for a smoother creamier product with minimal impact on the sensory texture.

In one embodiment, in a pudding, whole grain gluten free flour which is a single grain or blend of several grains which is a blend of five different grains such as amaranth, quinoa, teff, millet, sorghum is used. Single whole grains such as ground rice, oats, millets, sorghum have also been used. Whole grain flours either individual or blends are also added as is or additionally roasted prior to use. In a smooth pudding formula, whole grain flour in the range of 4-7% is added to the dry mix of the formulation along with sweeteners and texturing agents and combined with milk and processed.

Whole grain flours need to be carefully chosen so that texture and flavor is compatible. Certain whole grains such as oats or whole grain blends comprising of quinoa, amaranth, teff, sorghum and millet when added at 7% levels result is a very thick pudding almost with a dough type consistency. Specific grains or grain blend and the levels need to be carefully selected in order to make a palatable whole grain pudding with the desired flavor and texture.

In one embodiment, whole grains in the range of 4-7% is added. Preferred is 4% level of a single whole grain such as sorghum. Natural starch and 2% milk is used along with sugar and flavors to make a whole grain chocolate pudding with desired flavor and texture.

In another embodiment, soy milk or rice milk or almond milk may be used.

In another embodiment, whole grain is admixed with sugar and milk and cooked to at least 180 F to ensure lower microbial counts and the slurry or concentrate is stored refrigerated. The whole grain slurry may also be aseptically processed at high temperatures. Whole grain levels of 11-15% before cooking and 10-13% after slurry is cooked is obtained. The slurry is added to the pudding formula with necessary adjustments to the solids and a smooth consistency pudding is obtained. The slurry may also be added to a post process to a fermented yogurt base similar to addition of a fruit puree and processed similarly. Whole grain slurry may be flavored with different components such as fruit flavors, chocolate, peanut butter, cheese and used in food service applications or as an ingredient for processed foods to enhance whole grain.

In another embodiment, whole grain flour is roasted to reduce the raw or bitter aftertastes prior to addition.

In another embodiment, sorghum or other sweetener syrup or ultrafiltered milk or rice milk or soy or almond milk is used to make the slurry or concentrate.

In another embodiment, slurry may be enriched with fiber, omega-3s or other functional ingredients, vitamins, minerals which enable additional claims besides whole grains to be made.

In another embodiment, whole grains are added to similar semi solid spoonable foods such as sauces, dips or other spoonable products either as part of the formula and processed or as a slurry.

### EXAMPLES

### Ready to Eat Pudding

The sensory properties of the pudding are impacted by type and nature of the whole grains and fiber and additional. functional components added.

In example 1, the following ingredients are mixed and processed stove top at 180 F for 5 mins and cooled to 40 F.

| | | |
|---|---|---|
| Sugar | 14-16 | g |
| Starch | 2-3 | g |
| Cocoa powder | 2-3 | g |
| Sorghum (whole grain) | 4-6 | g |
| Salt, flavors | 0.2-0.5 | g |
| Fiber (soluble corn) | 3-5 | g |
| Milk (2%) | 72-75 | g |

The finished product has a nice smooth consistency, has a good flavor with no bitter notes and may be labeled as natural and gluten free. Starch (Novation 3300) from National Starch, NJ and whole grain sorghum flour from ConAgra Mills, Omaha, Nebr. is used. On a sensory scale of 1-5 where 5 is considered very good, the finished product has a overall sensory acceptance of 3.5. Photo of sample is attached.

### Example 2

In this example, effect of different whole grains on flavor and texture were evaluated. The following base formula was used.

| | | |
|---|---|---|
| Sugar | 26 | g |
| Starch | 4 | g |
| Cocoa | 5 | g |
| Salt/flavors/natural sweetness enhancers | 0.815-1.31 | g |
| Whole grains | 13 | g |
| 2% milk | 150-151 | g (adjust to 200 g) |

2:3—Whole grain blend 13 g (quinoa, amaranth, sorghum, teff and millet) was used.
2:4—Toasted finely milled whole grain rice 9 g and 4 g whole grain blend (quinoa, amaranth, sorghum, teff and millet) was used.
2:5—Toasted whole grain oats 9 g and 4 g whole grain blend (quinoa, amaranth, sorghum, teff and millet) was used.

### Sensory Characteristics:

2:3 was too thick and pasty and had a bitter note, sample 2:4 had rice notes but was of smoother consistency and sample 2:5 was similar to sample 2:3 in consistency. Oats and whole grain blend seem to absorb more water and result in a pasty texture while sample 2.4 with rice and less amount of whole grain blend had a smoother consistency.

In comparison to rice and oats, whole grain rice would be preferred from a smoother texture consistency. Photos of samples attached.

Whole grain millet untoasted and toasted was also tried. In summary, whole grain sorghum as see in example 1 had the best texture and clean flavor with no bitter or grain flavor notes.

### Example 3

Whole grain slurry or concentrate was prepared with sorghum with and without whole grain blend.
3.a. Whole grain slurry/concentrate (sorghum with whole grain blend) Sorghum and whole grain blend (7.5 g each) was combined with 7 g sugar and 66 g 2% milk. The above blend was mixed and heated at 175 F for 3-5 mins until thickened. Final yield was 85% resulting in 20% whole grain in final slurry or concentrate.

The slurry or concentrate was substituted for whole grain flour as follows:

| | A (with WG flour) | | B (with WG slurry/concentrate) |
|---|---|---|---|
| Sugar | 29.5 | g | 29.5 g |
| Starch | 4 | g | 4 g |
| Cocoa | 5 | g | 5 g |
| Salt/flavors | 0.63 | g | 0.63 g |
| Fiber | 3 | g | 3 g |
| WG (sor/blend) | 8 | g (4:4) | — |
| WG slurry | | | 38 g |
| 2% milk | 150 | g | 118 g |

Slurry was mixed with the milk in B and dry ingredients blended. Both products were heated at 180 F for 5 minutes and cooled. Slurry or concentrate sample may be slightly thinner in consistency and may be slightly lumpy. The slurry or concentrate may need to be homogenized for smoother consistency. pH of the slurry is neutral and hence refrigeration may be preferred. Aseptic processing may also be done to make a shelf stable slurry.

3b: Whole Grain Slurry/Concentrate with Sorghum:

Whole grains sorghum (15 g) was combined with 7 g sugar and 110 g 2% milk and heated at 175 F for 3 minutes. The slurry thickened to a good consistency and had a neutral flavor. Photo attached.

While the disclosures have been described with the embodiments, various changes may be made and ingredients substituted without departing from the scope of the disclosure by those skilled in the art.

What is claimed is:

1. A composition comprising: a spoonable, creamy semisolid food product such as a RTE pudding containing whole grains either added as flour or slurry that has been adequately processed at high temperatures, either aseptic or UHT to ensure shelf life either at room temperature or refrigerated where the whole grain addition allows for a smooth and creamy texture product.

2. The composition of claim 1, wherein the whole grain may be a single grain or blend of several whole grains wherein the whole grain comprises 7-10% of the composition and the flour is additionally toasted or whole grain is roasted and finely milled to improve the flavor.

3. The composition of claim 1 wherein whole grain preferably sorghum is used due to its neutral taste and minimal impact of textural characteristics for a smooth creamy RTE pudding.

4. The composition of claim 1, wherein the food product may be but not limited to puddings, mousses, dips, sauces, spreads and may contain additional nutritionally enhanced ingredients such as fiber, high protein, either by use of ultafiltered high protein milk vitamins, minerals or other functional ingredients that allow other healthy claims.

5. The composition of claim 1, wherein the food product such as puddings, mousses may be low sugar or sweetened with natural or artificial sweeteners and additional filler ingredients may be added.

6. A method of preparation of a whole grain slurry or a thick concentrate which is neutral in pH wherein whole grain flour or fine powder is mixed with sugar or other ingredients and may include but not limited to other functional ingredients such as fiber and preferably contains but not limited to milk as the liquid component and the slurry ingredients are mixed and processed at high temperatures and homogenized to produce a neutral pH whole grain slurry or concentrate which may be aseptically processed to make a shelf stable concentrate or may be refrigerated.

7. A composition wherein the whole grain slurry or concentrate from claim 5 may be added to a pudding formula to produce a smooth textured RTE pudding.

8. A composition wherein the whole grain slurry or concentrate form claim 5 may be added post process such as to a fermented yogurt to enhance whole grain in a yogurt product.

9. A composition wherein the whole grain slurry or concentrate form claim 5 may be added to a sauce and processed to enhance whole grain in a sauce.

10. A composition wherein the whole grain slurry is flavored with additional components to enhance flavor, texture shelf life and packaged appropriately for use in multiple industrial or food service applications.
